(19) United States
(12) Patent Application Publication
(10) Pub. No.: US 2016/0012389 A1
(43) Pub. Date: Jan. 14, 2016

(54) METHOD, APPARATUS, AND SYSTEM FOR SYNCHRONIZING INVENTORY INFORMATION

(71) Applicant: TENCENT TECHNOLOGY (SHENZHEN) COMPANY LIMITED, Shenzhen (CN)

(72) Inventor: Jun XIE, Shenzhen (CN)

(21) Appl. No.: 14/864,615

(22) Filed: Sep. 24, 2015

Related U.S. Application Data
(63) Continuation of application No. PCT/CN2014/073989, filed on Mar. 25, 2014.

(30) Foreign Application Priority Data
Mar. 25, 2013 (CN) 201310096299.0

(51) Int. Cl. G06Q 10/08

(52) U.S. Cl. CPC G06Q 10/087

(57) ABSTRACT

The present disclosure provides a method, apparatus, and system for synchronizing inventory information. The method includes: separating main inventory information on a server into at least one piece of sub-inventory information; receiving order information; processing the order information according to a piece of sub-inventory information corresponding to the order information; updating the main inventory information according to the order information; and updating the at least one piece of sub-inventory information according to updated main inventory information. Correspondingly, the present disclosure also provides an apparatus and system for synchronizing the inventory information.

### CROSS REFERENCE TO RELATED APPLICATIONS

The application is a continuation application of PCT Patent Application No. PCT/CN2014/073989, entitled “Method, Apparatus, and System for Synchronizing Inventory Information”, filed on Mar. 25, 2014, which claims the benefit of Chinese Patent Application No. 201310096299.0, entitled “Method and System for synchronizing Inventory Information”, filed on Mar. 25, 2013, the disclosure of which is incorporated herein in its entirety by reference.

### TECHNICAL FIELD

The present disclosure relates to information processing technologies, and particularly to a method, apparatus, and system for synchronizing inventory information.

### BACKGROUND

In an E-commerce information processing platform, there is an application situation where multiple sale modules process order requests according to inventory information of a same main inventory module. In this case, the multiple sale modules need to synchronize inventory information with the main inventory module.

FIG. 1 shows a schematic diagram of a system for synchronizing inventory information between multiple sale modules and a main inventory module in the traditional art.

The system shown in FIG. 1 includes multiple sale modules on the clients (e.g., mobile terminals, PCs, intelligent terminals, etc.) of respective distributors, and in FIG. 1 only sale modules 101, 102, and 103 are shown for illustration purpose. The system in FIG. 1 further includes a main inventory module 104 on a server (e.g., a computer) of a supplier.

The sale modules 101, 102, and 103 respectively communicate with the main inventory module 104 via a network 10 to obtain main inventory information from the main inventory module 104, process order requests from customers according to the obtained main inventory information, and send generated order information to the main inventory module 104. The main inventory module 104 processes the order information and updates the main inventory information according to the received order information.

As seen from FIG. 1, the respective sale modules 101, 102, and 103 in the system all process order requests from the customers according to the inventory information of the main inventory module 104. However, since the respective sale modules communicate with the main inventory module directly, there is no information communication between the sale modules. In addition, when the main inventory module processes the order requests, there is processing lag, and the processing lag will be passed to the respective sale modules and causes there is repetition and lag in the main inventory information used by the respective sale modules to generate the order requests, which further causes the sale module to generate wrong order requests.

For example, a supplier has inventory of 10 pieces of clothing, and the information “10 pieces of clothing” is notified to distributors A, B, and C. In case that the distributor A receives an order of 6 pieces of clothing from his customer and distributor B receives an order of 5 pieces of clothing from a customer, since the distributors A and B determines that there are 10 pieces of clothing and are enough for them to purchase, if both of the distributors A and B submit their orders, one of them whoever is late to submit his order request will not be supplied with enough clothing, and his order will be failure.

### SUMMARY

The present disclosure provides a method, apparatus, and system for synchronizing inventory information, which can reduce the repetition and lag in inventory information based on which distributors generate order information, and thus can reduce wrong order information being generated.

In one aspect, the present disclosure provides a method for synchronizing inventory information, which includes: separating main inventory information on a server into at least one piece of sub-inventory information; receiving order information; processing the order information according to a piece of sub-inventory information corresponding to the order information; updating the main inventory information according to the order information; and updating the at least one piece of sub-inventory information according to updated main inventory information.

In another aspect, the present disclosure provides an apparatus for synchronizing inventory information, which includes: a memory; one or more processors; one or more programs stored in the memory and configured to be executed by the one or more processors, the one or more programs including instructions to: separate main inventory information on a server into at least one piece of sub-inventory information; receive order information; process the order information according to a piece of sub-inventory information corresponding to the order information; update the main inventory information according to the order information; and update the at least one piece of sub-inventory information according to updated main inventory information.

In a third aspect, the present disclosure provides a system for synchronizing inventory information, which includes: a server and at least one client, wherein the server comprises: a memory; one or more processors; one or more programs stored in the memory and configured to be executed by the one or more processors, the one or more programs including instructions to: separate main inventory information on the server into at least one piece of sub-inventory information corresponding to the at least one clients; receive order information from the at least one client; process the order information according to a piece of sub-inventory information corresponding to the order information; update the main inventory information according to the order information; and update the at least one piece of sub-inventory information according to updated main inventory information; and the client includes: a memory; one or more processors; one or more programs stored in the memory and configured to be executed by the one or more processors, the one or more programs including instructions to: receive an order request; process the order request according to sub-inventory information corresponding to the client and generate order information; and send the order information to the server.

### BRIEF DESCRIPTION OF THE DRAWINGS

For a better understanding of the present disclosure, reference should be made to the Detailed Description below, in conjunction with the following drawings in which like reference numerals refer to corresponding parts throughout the figures.

FIG. 1 shows a schematic diagram of a system for synchronizing inventory information between multiple sale modules and a main inventory module in the traditional art;

FIG. 2 shows a schematic diagram of a system for synchronizing inventory information according to an example of the present disclosure;

FIG. 3 shows a flowchart of a method for synchronizing inventory information according to an example of the present disclosure;

FIG. 4 shows a flowchart of a method for synchronizing inventory information according to an example of the present disclosure; and

FIG. 5 shows a schematic diagram of an apparatus for synchronizing inventory information according to an example of the present disclosure.

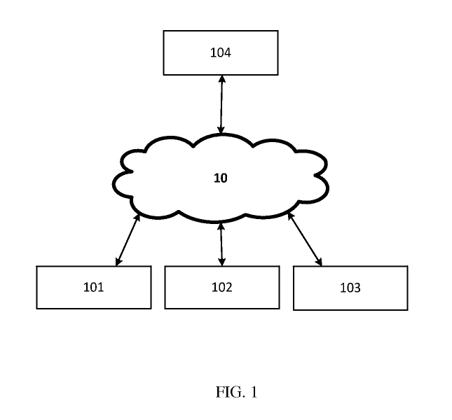

### DETAILED DESCRIPTION

FIG. 2 shows a schematic diagram of a system for synchronizing inventory information according to examples of the present disclosure.

As shown in FIG. 2, the system includes a main inventory module 201, multiple sub-inventory modules 202, and multiple sale modules 203. The main inventory module 201 and the multiple sub-inventory modules 202 are on a server 30 (e.g., a computer) of a supplier. The multiple sale modules are on respective client 20 (e.g., a mobile terminal, a PC, an intelligent terminal, etc.) of multiple distributors. The multiple sub-inventory modules 202 communicate with the main inventory module 201 and different sale modules 203. The sub-inventory modules 202 and the sale modules 203 can be one to one correspondence.

The main inventory module 201 receives order information (e.g., including the name of a distributor, the category and amount of products to purchase, and the payments, etc.) sent from respective sale modules 203 via the network, updates main inventory information in the main inventory module 201 (e.g., reducing the amount of inventory according to the order information), separates the main inventory information in the main inventory module 201 into sub-inventory information corresponding to respective sale modules 203, and sets expiration time for the sub-inventory information of the respective sale modules 203. The inventory information for example includes the product information and inventory amount.

Each sub-inventory module 202 stores the sub-inventory information and expiration time of the sub-inventory information allocated by the main inventory module 201, and synchronizes its sub-inventory information with the main inventory module 201.

Each sale module 203 processes order requests according to the sub-inventory information in the sub-inventory module 202 associated with it, and sends generated order information to the main inventory module 201.

Specifically, the main inventory module 201 determines changes of the inventory information corresponding to each sale module 203 according to the order information of each sale module 203, and separates the main inventory information into sub-inventory information corresponding to the respective sale modules 203.

By determining the changes of the inventory information corresponding to each sale module 203 according to the order information of each sale module 203, and further allocating the sub-inventory information to each sale module 203 according to the changes of the inventory information, the sub-inventory information allocated to each sale module can be adapted to the changes of inventory of each sale module, and further the number of re-allocating the inventory information is reduced, and the time and resources that are needed to allocate the inventory information are saved.

The main inventory module 201 specifically may set same expiration time for the sub-inventory information of different sale modules. Preferably, the main inventory module 201 may also set different expiration time for the sub-inventory information of different sale modules so as to be adapted to different changes of the inventory of respective sale modules, etc.

The main inventory module 201 can set synchronization time, and when the synchronization time arrives, the main inventory module 201 updates the sub-inventory information of the respective sale modules 203 according to the main inventory information and the order information of the respective sale modules 203.

The main inventory module 201 sets the synchronization time, and when the synchronization time arrives, updates the sub-inventory information of the respective sale modules 203 according to the order information of the respective sale modules 203. Further, the main inventory module 201 can adjust the sub-inventory information of the respective sale modules 203 according to the actual main inventory information of the main inventory module 201 and the order information actually generated by the respective sale modules 203, to enable the sub-inventory information allocated to the respective sale modules 203 to match with the inventory change information of the respective sale modules themselves.

The sum of the sub-inventory information of the respective sale modules 203 can equal to the main inventory information in the main inventory module 201. Or, the sum of the sub-inventory information of the respective sale modules 203 may be smaller than the main inventory information of the main inventory module 201 so that there is inventory remaining for backup. On one hand, the impact caused when the main inventory module 201 initially allocates inventory information for all the sub-inventory modules 202, there is information processing lag of the main inventory module 201 for the sub-inventory information of the respective sub-inventory modules 202 can be reduced. On the other hand, when the sub-inventory information of a certain sale module 203 is smaller than a predefined value, additional inventory can be supplemented to the sale module 203. In this way, only the sub-inventory information of a sale module 203 where the inventory information changes fast needs to be updated, while the sub-inventory information of a sale module 203 where the inventory information changes slowly needs not to be updated, thus the resources needed to update the sub-inventory information being saved.

Before the expiration time of sub-inventory information of a sub-inventory module 202 is reached, if the sub-inventory information is smaller than a predefined value, then the sub-inventory module 202 can request the main inventory module 201 to update the sub-inventory information.

Specifically, as an example, the supplier separates the main inventory information of 10 pieces of clothing according to sale conditions of distributors A, B, and C:

1) 3 pieces to a first sub-inventory module corresponding to distributor A, then distributor A knows he can sell 3 pieces at the most;

2) 3 pieces to a second sub-inventory module corresponding to distributor B, then distributor B knows he can sell 3 pieces at the most; and

3) 4 pieces to a third sub-inventory module corresponding to distributor C, then distributor C knows he can sell 4 pieces at the most.

In this way, there will be fewer conflicts among the distributors A, B, and C.

Further, the supplier sets expiration time for the sub-inventory information of the sub-inventory modules respectively, for example, before 12:00 PM, Mar. 12, 2014. The expiration time can be different too.

Each time when the distributors A, B, and C obtain the sub-inventory information allocated to them, there will be expiration time. When the expiration time is reached, the supplier will adjust the sub-inventory information according to the sale conditions in the last round for the distributors A, B, and C, and sets next expiration time.

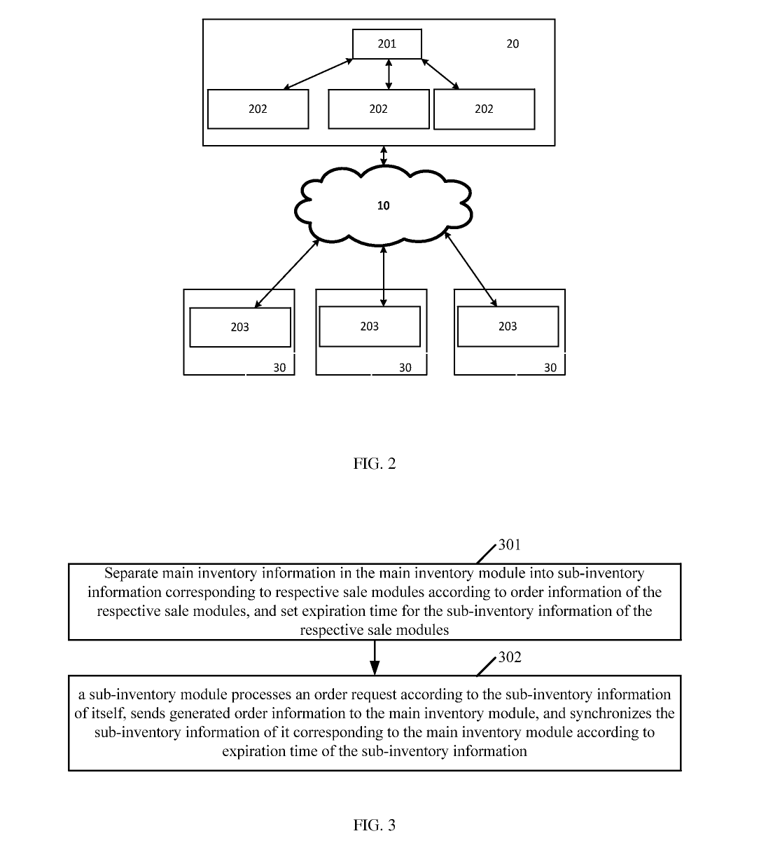

Corresponding to the system for synchronizing the inventory information, the present disclosure further provides a method for synchronizing the inventory information, as shown in FIG. 3.

FIG. 3 shows a flow chart of the method for synchronizing the inventory information provided by the present disclosure.

As shown in FIG. 3, the method includes the following process.

At block 301, main inventory information in the main inventory module is separated into sub-inventory information corresponding to respective sale modules according to order information of the respective sale modules, and expiration time is respectively set for the sub-inventory information of the respective sale modules.

At block 302, a sub-inventory module processes an order request according to the sub-inventory information of itself, sends generated order information to the main inventory module, and synchronizes the sub-inventory information of it corresponding to the main inventory module according to expiration time of the sub-inventory information.

The main inventory module receives the order information sent from the respective sale modules, and updates the main inventory information in the main inventory module according to the order information.

Separating the main inventory information into the sub-inventory information corresponding to the respective sale modules according to the order information of the respective sale modules may include: determining changes of the sub-inventory information corresponding to each sale module according to the order information of each sale module, and separating the main inventory information into sub-inventory information corresponding to the respective sale modules according to the changes of the sub-inventory information of the respective sale modules.

Setting the expiration time for the sub-inventory information of the respective sale modules may include: setting same expiration time for the sub-inventory information of different sale modules, or setting different expiration time for the sub-inventory information of the different sale modules.

The method shown in FIG. 3 may further include: setting synchronization time, and when the synchronization time arrives, the main inventory module updating the sub-inventory information of the respective sale modules according to the main inventory information and the order information of the respective sale modules.

The sum of the sub-inventory information of the respective sale modules 203 can equal to the main inventory information in the main inventory module 201. Or, the sum of the sub-inventory information of the respective sale modules 203 may be smaller than the main inventory information of the main inventory module 201 so that there is inventory remaining for backup.

As is seen from the above examples, by setting the sub-inventory modules between the main inventory module and the sale modules, the main inventory module communicates with all the sub-inventory modules. Each sale module communicates with a sub-inventory module corresponding to it and processes order requests according to the sub-inventory module corresponding to it. Since the sub-inventory information corresponding to the respective sub-inventory modules is allocated by the main inventory module and each sale module communicates with the sub-inventory module corresponding to it. Therefore, the repetition in inventory information based on which the sale module generates order requests can be reduced. Further, since the sub-inventory information is set with expiration time, and each sub-inventory module synchronizes the sub-inventory information with the main inventory module according to the expiration time of the sub-inventory information, the lag in updating the main inventory information in the main inventory module caused by lag in processing information will not affect the sub-inventory information of the respective sale modules, which further reduces the lag of inventory information based on which the sale module generates order request, and therefore reduces wrong order request.

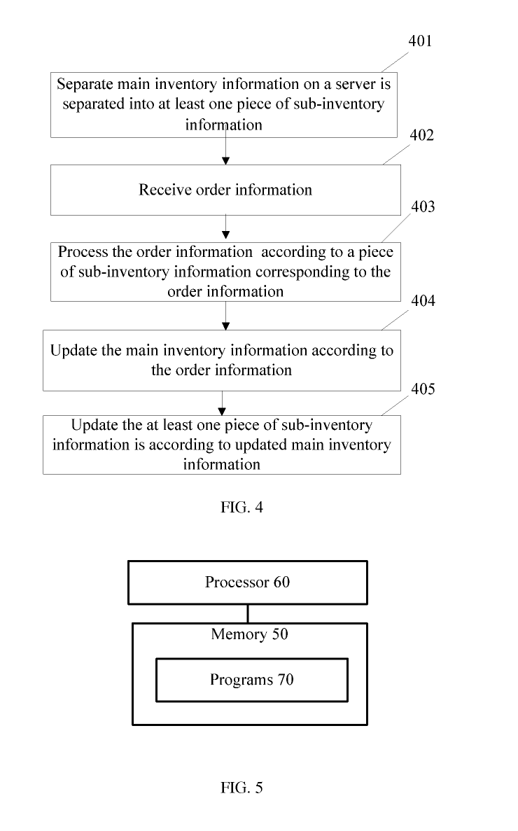

FIG. 4 shows a flowchart of a method for synchronizing inventory information according to an example of the present disclosure.

The method includes the following process.

At block 401, main inventory information on a server is separated into at least one piece of sub-inventory information.

At block 402, order information is received.

At block 403, the order information is processed according to a piece of sub-inventory information corresponding to the order information.

At block 404, the main inventory information is updated according to the order information.

At block 405, the at least one piece of sub-inventory information is updated according to updated main inventory information.

Further, the method includes: setting expiration time for the at least one piece of sub-inventory information; and updating the at least one piece of sub-inventory information when the expiration time is reached.

Setting expiration time for the at least one piece of sub-inventory information includes: setting same or different expiration time for the at least one piece of sub-inventory information.

The method further includes: setting synchronization time; and updating the at least one piece of sub-inventory information when the synchronization time arrives.

In the method, a sum of the at least one piece of sub-inventory information equals to or is smaller than the main inventory information; or a sum of the at least one piece of sub-inventory information is smaller than the main inventory information, and before the expiration time of the at least one piece of sub-inventory information is reached, if the at least one sub-inventory information is smaller than a predefined value, the at least one sub-inventory information is updated according to the main inventory information.

FIG. 5 shows an apparatus for synchronizing inventory information according to the present disclosure. The apparatus includes: a memory 50; one or more processors 60; one or more programs 70 stored in the memory and configured to be executed by the one or more processors, the one or more programs including instructions to: separating main inventory information on a server into at least one piece of sub-inventory information; receiving order information; processing the order information according to a piece of sub-inventory information corresponding to the order information; updating the main inventory information according to the order information; and updating the at least one piece of sub-inventory information according to updated main inventory information.

In the apparatus, the one or more programs include instructions to: set expiration time for the at least one piece of sub-inventory information; and update the at least one piece of sub-inventory information when the expiration time is reached.

In the apparatus, setting expiration time for the at least one piece of sub-inventory information includes: setting same or different expiration time for the at least one piece of sub-inventory information.

In the apparatus, the one or more programs include instructions to: set synchronization time; and update the at least one piece of sub-inventory information when the synchronization time arrives.

In the apparatus, a sum of the at least one piece of sub-inventory information equals to or is smaller than the main inventory information; or a sum of the at least one piece of sub-inventory information is smaller than the main inventory information, and before the expiration time of the at least one piece of sub-inventory information is reached, if the at least one sub-inventory information is smaller than a predefined value, the at least one sub-inventory information is updated according to the main inventory information.

The above examples may be implemented by hardware, software, firmware, or a combination thereof. For example the various methods, processes and functional modules described herein may be implemented by a processor (the term processor is to be interpreted broadly to include a CPU, processing unit/module, ASIC, logic module, or programmable gate array, etc.). The processes, methods and functional modules may all be performed by a single processor or split between several processors; reference in this disclosure or the claims to a ‘processor’ should thus be interpreted to mean ‘one or more processors’. The processes, methods and functional modules are implemented as machine readable instructions executable by one or more processors, hardware logic circuitry of the one or more processors or a combination thereof. The modules, if mentioned in the aforesaid examples, may be combined into one module or further divided into a plurality of sub-modules. Further, the examples disclosed herein may be implemented in the form of a software product. The computer software product is stored in a non-transitory storage medium and includes a plurality of instructions for making an electronic device implement the method recited in the examples of the present disclosure.

What is claimed is:

1. A method for synchronizing inventory information, comprising:
separating main inventory information on a server into at least one piece of sub-inventory information;
receiving order information;
processing the order information according to a piece of sub-inventory information corresponding to the order information;
updating the main inventory information according to the order information; and
updating the at least one piece of sub-inventory information according to updated main inventory information.

2. The method according to claim 1, further comprising:
setting expiration time for the at least one piece of sub-inventory information; and
updating the at least one piece of sub-inventory information when the expiration time is reached.

3. The method according to claim 2, wherein
a sum of the at least one piece of sub-inventory information equals to or is smaller than the main inventory information; or
a sum of the at least one piece of sub-inventory information is smaller than the main inventory information, and before the expiration time of the at least one piece of sub-inventory information is reached, if the at least one sub-inventory information is smaller than a predefined value, the at least one sub-inventory information is updated according to the main inventory information.

4. The method according to claim 2, wherein setting expiration time for the at least one piece of sub-inventory information comprises:
setting same or different expiration time for the at least one piece of sub-inventory information.

5. The method according to claim 4, wherein
a sum of the at least one piece of sub-inventory information equals to or is smaller than the main inventory information; or
a sum of the at least one piece of sub-inventory information is smaller than the main inventory information, and before the expiration time of the at least one piece of sub-inventory information is reached, if the at least one sub-inventory information is smaller than a predefined value, the at least one sub-inventory information is updated according to the main inventory information.

6. The method according to claim 2, further comprising:
setting synchronization time; and
updating the at least one piece of sub-inventory information when the synchronization time arrives.

7. The method according to claim 6, wherein
a sum of the at least one piece of sub-inventory information equals to or is smaller than the main inventory information; or
a sum of the at least one piece of sub-inventory information is smaller than the main inventory information, and before the expiration time of the at least one piece of sub-inventory information is reached, if the at least one sub-inventory information is smaller than a predefined value, the at least one sub-inventory information is updated according to the main inventory information.

8. The method according to claim 1, wherein
a sum of the at least one piece of sub-inventory information equals to or is smaller than the main inventory information; or
a sum of the at least one piece of sub-inventory information is smaller than the main inventory information, and before the expiration time of the at least one piece of sub-inventory information is reached, if the at least one sub-inventory information is smaller than a predefined value, the at least one sub-inventory information is updated according to the main inventory information.

9. An apparatus for synchronizing inventory information, comprising:
a memory;
one or more processors;
one or more programs stored in the memory and configured to be executed by the one or more processors, the one or more programs including instructions to:
separate main inventory information on a server into at least one piece of sub-inventory information;
receive order information;
process the order information according to a piece of sub-inventory information corresponding to the order information;
update the main inventory information according to the order information; and
update the at least one piece of sub-inventory information according to updated main inventory information.

10. The apparatus according to claim 9, wherein
a sum of the at least one piece of sub-inventory information equals to or is smaller than the main inventory information; or
a sum of the at least one piece of sub-inventory information is smaller than the main inventory information, and before the expiration time of the at least one piece of sub-inventory information is reached, if the at least one sub-inventory information is smaller than a predefined value, the at least one sub-inventory information is updated according to the main inventory information.

11. The apparatus according to claim 9, wherein the one or more programs includes instructions to:
set expiration time for the at least one piece of sub-inventory information;
update the at least one piece of sub-inventory information when the expiration time is reached.

12. The apparatus according to claim 11, wherein
a sum of the at least one piece of sub-inventory information equals to or is smaller than the main inventory information; or
a sum of the at least one piece of sub-inventory information is smaller than the main inventory information, and before the expiration time of the at least one piece of sub-inventory information is reached, if the at least one sub-inventory information is smaller than a predefined value, the at least one sub-inventory information is updated according to the main inventory information.

13. The apparatus according to claim 11, wherein setting expiration time for the at least one piece of sub-inventory information comprises:
set same or different expiration time for the at least one piece of sub-inventory information.

14. The apparatus according to claim 13, wherein
a sum of the at least one piece of sub-inventory information equals to or is smaller than the main inventory information; or
a sum of the at least one piece of sub-inventory information is smaller than the main inventory information, and before the expiration time of the at least one piece of sub-inventory information is reached, if the at least one sub-inventory information is smaller than a predefined value, the at least one sub-inventory information is updated according to the main inventory information.

15. The apparatus according to claim 11, wherein the one or more programs includes instructions to:
set synchronization time; and
update the at least one piece of sub-inventory information when the synchronization time arrives.

16. The apparatus according to claim 15, wherein
a sum of the at least one piece of sub-inventory information equals to or is smaller than the main inventory information; or
a sum of the at least one piece of sub-inventory information is smaller than the main inventory information, and before the expiration time of the at least one piece of sub-inventory information is reached, if the at least one sub-inventory information is smaller than a predefined value, the at least one sub-inventory information is updated according to the main inventory information.

17. A system for synchronizing inventory information, comprising a server and at least one client, wherein the server comprises:
a memory;
one or more processors;
one or more programs stored in the memory and configured to be executed by the one or more processors, the one or more programs including instructions to:
separate main inventory information on the server into at least one piece of sub-inventory information corresponding to the at least one clients;
receive order information from the at least one client;
process the order information according to a piece of sub-inventory information corresponding to the order information;
update the main inventory information according to the order information; and
update the at least one piece of sub-inventory information according to updated main inventory information; and
the client comprises:
a memory;
one or more processors;
one or more programs stored in the memory and configured to be executed by the one or more processors, the one or more programs including instructions to:
receive an order request;
process the order request according to sub-inventory information corresponding to the client and generate order information; and
send the order information to the server.
